(19) United States
(12) Patent Application Publication
(10) Pub. No.: US 2007/0084500 A1
(43) Pub. Date: Apr. 19, 2007

(54) Double-jointed mounting for solar panel

(76) Inventor: Chi Gon Chen, Guang Zhou (CN)

Correspondence Address: Alan R. Thiele;Strasburger & Price, LLP, Suite 4400, 901 Main St., Dallas, TX, 75202, US

(21) Appl. No.: 11/515,094

(22) Filed: Aug. 31, 2006

Related U.S. Application Data
(60) Provisional application No. 60/713,531, filed on Sep. 1, 2005.

(51) Int. Cl. H02N 6/00

(52) U.S. Cl. 136/244

(57) ABSTRACT

The device disclosed herein is a double jointed mounting for a solar panel which enables the solar panel to move so that its orientation with the sun is optimal for the collection of sunlight for the subsequent conversion to electrical energy. The double jointed mounting consists of a mount housing which contains two ball and socket joints located at either end of the mount housing. The solar panel can rotate independently about either ball and socket joint to maintain the optimal position for the collection of solar energy.

### CROSS REFERENCE TO RELATED APPLICATIONS

This application makes reference to and seeks the benefit of provisional application No. 60/713,531 filed on Sep. 1, 2005.

### STATEMENT REGARDING FEDERALLY SPONSORED RESEARCH OR DEVELOPMENT

The invention disclosed in this utility patent application was no the subject of federally sponsored research or development.

### FIELD

The present invention pertains to devices which convert solar energy into electrical energy; more particularly, the present invention pertains to devices having an adjustable mounting for a solar panel.

### BACKGROUND

Solar energy continues in popularity as an environmentally friendly renewable source of energy. In addition to large applications where massive solar panels are used to convert solar energy into electrical energy for use in commercial electrical systems, solar panels have found their way into smaller applications, such as lights for walkways in residential applications.

In some larger applications, to maximize the collection of solar energy, the solar panels are actually movable and contain computer controls which cause the mounting for the solar panel to actually track the path of the sun as the sun moves through the sky. Such movable, tracking mountings are complex and expensive.

In smaller applications, a substantially horizontal solar panel is used to gather solar energy and convert the solar energy into electrical energy. For residential walkway illumination lamps, which are only used in the first few hours of darkness each evening, exposure of a substantially horizontal solar panel to the sun each day provides all of the needed electrical power.

However, as more and more users are discovering the great utility provided by solar panels and finding more and more applications for using solar panels, users are affixing solar panels to devices requiring more and more electrical power. Accordingly, there is a need to extract greater amounts of solar energy from the sun's rays and convert this solar energy into larger amounts of electrical energy. One solution to this problem is to follow the lead of the installers of the massive solar panels and create a small system which includes a computer controlled movable mounting for the solar panel to enable the mounting for the solar panel to track the sun through the sky each day. However, the cost of such systems would be prohibitive for small systems, such as those used to power walkway lights or gate openers.

Accordingly, there remains a need in the art for a simple, inexpensive system which will increase the amount of solar energy impinging on the surface of a solar panel to increase the amount of electrical energy produced, thereby expanding the use of solar panel powered devices to devices that require greater amounts of electrical energy.

### SUMMARY

The double-jointed solar panel mounting system described in the instant application provides a convenient method to adjust a solar panel which converts sunlight into electricity, so that the solar panel is in a perpendicular orientation to the rays of the sun and able thereby, to capture more of the energy of the sun. The double-jointed solar panel mounting system disclosed herein is constructed and arranged to have two ball and socket joints. One of the ball and socket joints is located above the solar powered lamp and the second ball and socket joint is located just below the solar panel. This double ball and socket joint assembly permits each ball and socket to move independently of the other ball and socket joint. As a result, the solar panel can be moved about the double ball and socket joint to remain in proper orientation to receive the rays of the sun without changing the direction that light is emitted from the solar powered lamp.

### BRIEF DESCRIPTION OF THE INVENTION

A better understanding of the double jointed mounting for a solar panel may be had by review of the following drawing/figures wherein:

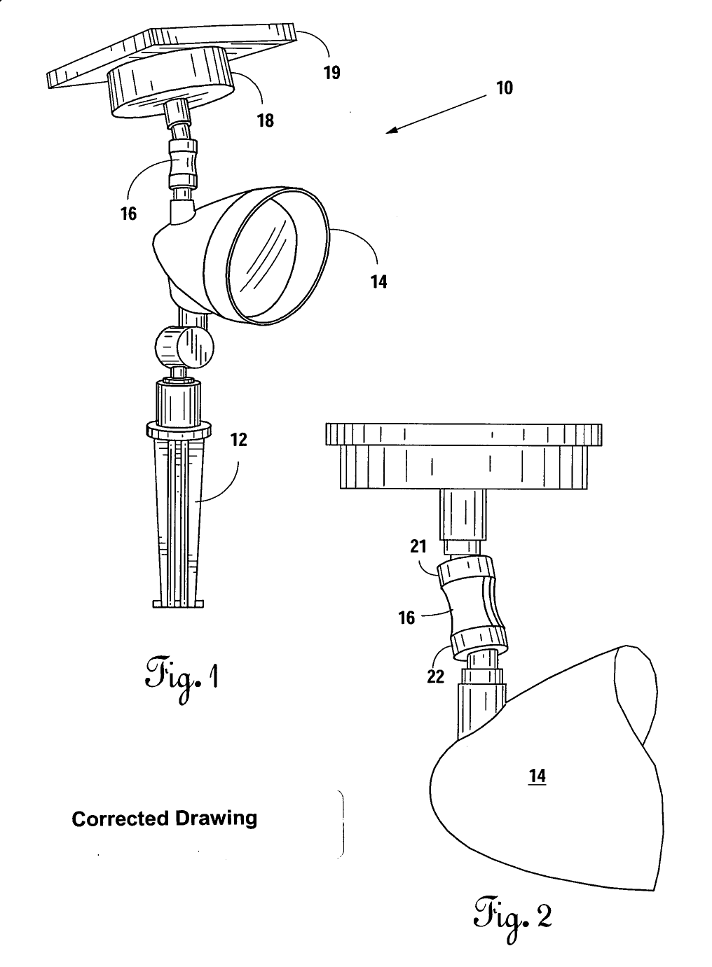

FIG. 1 is a perspective view of a solar panel and lamp assembly including the present invention;

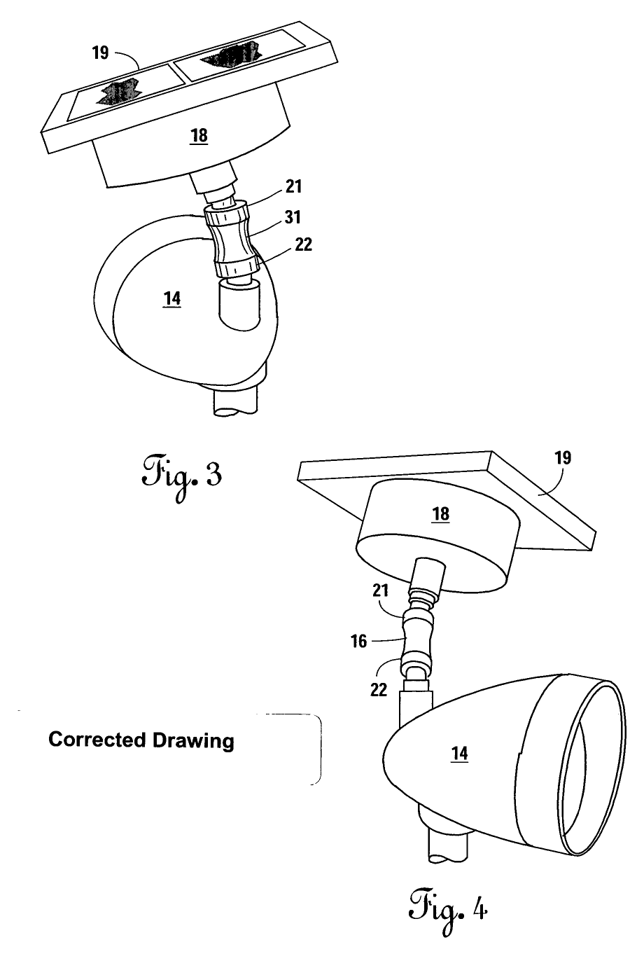

FIG. 2 is a perspective view from the right rear of the double jointed mounting for a solar panel disclosed in the instant application;

FIG. 3 is a perspective view from the rear of the double jointed mounting for a solar panel disclosed in the instant application;

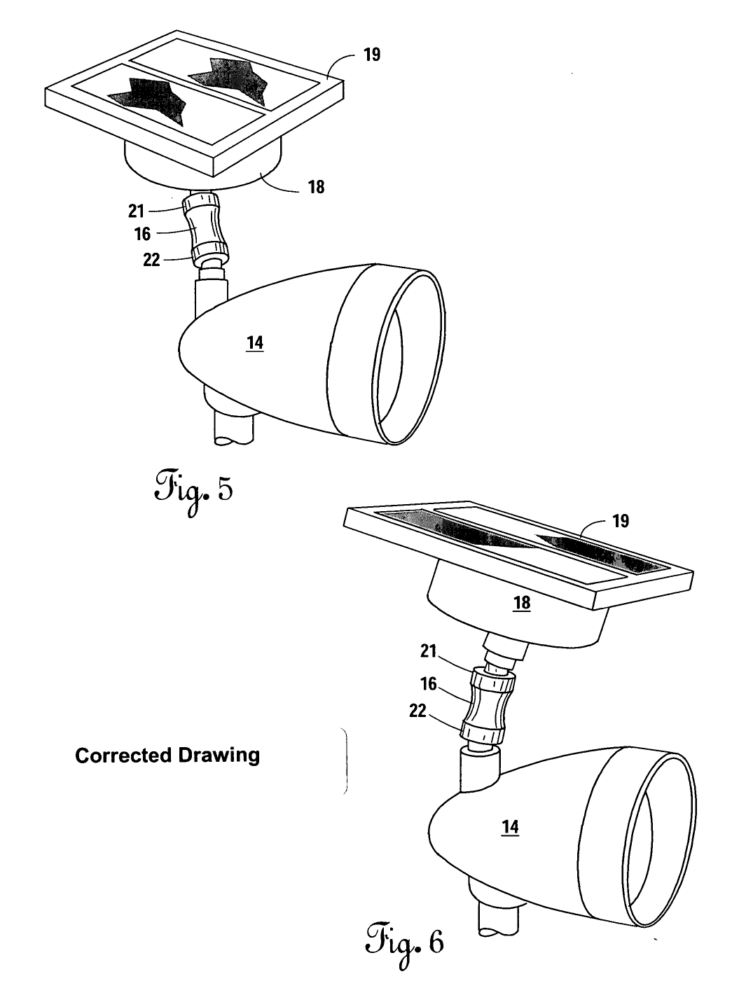

FIG. 4 is a perspective view from the right front of the solar panel and lamp assembly with the solar panel tilted from the substantially horizontal position;

FIG. 5 is a perspective view from the right front of the solar panel and lamp assembly similar to FIG. 4 but with the solar panel tilted from the substantially horizontal position;

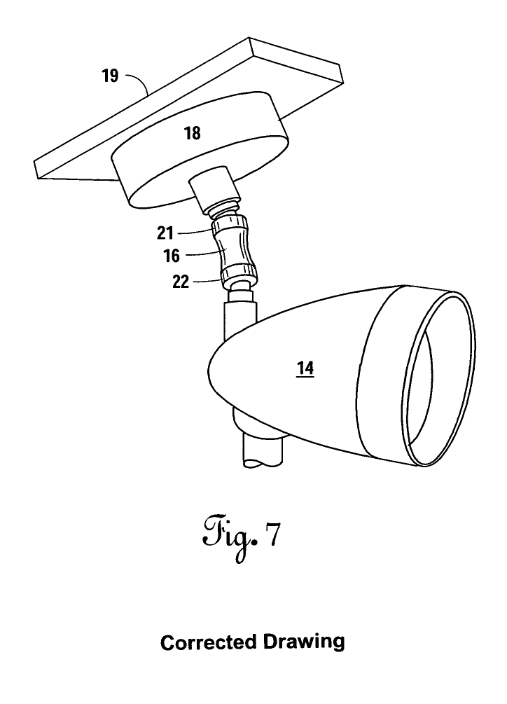

FIG. 6 is a perspective view from the right front of the solar panel and lamp assembly similar to FIG. 4 but with the solar panel tilted forward from the substantially horizontal position;

FIG. 7 is a perspective side view from the right front of the solar panel and lamp assembly with the solar panel tilted rearward from the substantially horizontal position.

### DESCRIPTION OF THE EMBODIMENTS

The double-jointed solar panel mounting system 10 of the present invention provides a simple, inexpensive way to increase the amount of solar energy impinging on the surface of a solar panel to increase the amount of electrical energy produced to enable the use of devices with solar panels that require greater amounts of electrical energy.

As shown in the accompany figures, the device to be powered by electrical energy obtained from the conversion of solar energy into electrical energy is a spot light or a flood light. Typically, such spot lights or flood lights are not powered by solar panels because of the large amount of electrical energy needed to illuminate such lights. But by use of the disclosed invention, such spot lights or flood lights can be used because of the disclosed solar panel mounting system which maximizes the amount of electrical energy that can be obtained from converting solar energy to electrical energy.

In many areas of the country, the sun does not pass directly overhead, but for a few days each year. Instead, the sun traces a path across the sky which does not maximize the electrical power that can be obtained from the conversion of solar energy into electrical energy by a substantially horizontal solar panel. To maximize the amount of energy converted from solar energy, it is necessary to change the mounting of the solar panel 19 to one in which the exposure of the solar panel 19 to the sun's rays is increased. The disclosed mounting of the solar panel 19 shown in the attached figures solves this problem. As shown in FIGS. 4, 5, 6, and 7, the solar panel 19 may be tilted almost 360 degrees about the axis of the double ball and socket joint 16 disclosed in this application.

In the disclosed embodiment of the invention as shown in FIG. 1, a solar panel system is used to convert solar energy into electrical energy. The electrical energy is typically stored in a battery (not shown)located in a housing 18 near the solar panel 19. When the lamp 14 is turned on, stored electricity from the battery powers the lamp 14. When the sun's rays hit the solar panel 19, the stored electricity removed from the batteries is replaced by the electrical energy obtained from the conversion of solar light into electricity.

What distinguishes the disclosed system 10 from other solar-powered devices is that the mounting 16 for the solar panel 19 is easily manually adjustable so that the solar panel 19 can be located so that it has maximized exposure to the sun's rays during a large portion of the day.

In the preferred embodiment shown in FIGS. 1, 2 and 3, two ball-and-socket joints 21, 22 are used. The ball portions of the ball-and-socket joints 22, 21 are located on the top surface of the lamp 14 and on the bottom surface of the solar panel 19, respectively. The socket portions of the ball-and-socket joints 21, 22 are located in a central holding member 16. The central holding member 16 is formed in two pieces. The pieces come together to form two sockets 21, 22 sized to fit around the ball from the solar panel 19 and the ball from the lamp 14. By using two ball-and-socket joints 21, 22, the user is able to position the solar panel 19 in a wide variety of different positions, irrespective of the orientation of the lamp 14.

As may be seen in FIGS. 2 and 3 the double-jointed mounting of the present invention includes two pieces connected together by a threaded fastener 31. At either end of each of the two pieces is a half socket 21, 22. Thus, when the threaded fastener 31 connecting the two pieces is tightened, a socket will be formed around the ball extending from the lamp 22 and the ball 21 extending from underneath the solar panel 19.

A user of the disclosed invention will place the lamp 14 in the place where it will be used. In the illustrated embodiment, a pole or a stake 12 extends downwardly from the lamp 14 for insertion into the ground. Once the lamp 14 has been positioned and properly aimed so that the light from the lamp 14 will illuminate a desired area, the user will then loosen the fastener 31 holding the mounting together so that the balls move within the sockets 21, 22. The solar panel 19 is then positioned so that it receives as close to direct sunlight for as long a period as possible during the day. In other situations, it may be necessary to position the solar panel 19 so that the shadows cast by nearby objects are avoided. When the solar panel 19 has been properly positioned, the threaded fastener 31 is tightened to hold the solar panel 19 in the position to receive the sun's rays.

Users may find it necessary to move the solar panel 19 during the various seasons of the year to maximize the amount of sunlight impinging on the solar panel 19. Such adjustment is made by loosening the threaded fastener 31 and making a small adjustment to the position of the solar panel 19 .

If the lamp 14 is moved to another location, the process described above may be repeated to reposition the solar panel 31 to where it receives the maximum amount of sunlight each day.

A person of reasonable skill in the art will recognize that there are a number of embodiments of the present invention which have not been specifically disclosed in the specification. Those other embodiments are included within this application within the scope and meaning of the appended claims.

What is claimed is:

1. A mounting system for a solar panel comprising:
a first ball positioned on an object to be powered by energy originating as solar energy;
a second ball positioned on a solar panel assembly;
a mounting bar having two sections connected by a threaded fastener, said mounting bar having a first socket and a second socket on each end constructed and arranged to surround said first ball and said second ball respectively;
whereby said solar panel assembly may be positioned to receive direct sunlight for a substantial portion of each day.

2. The mounting system for a solar panel defined in claim 1 wherein said object to be powered is a lamp.

3. A device for adjusting the orientation of a substantially planar object comprising:
a first ball positioned on the base supporting said substantially planar object;
a second ball positioned on said substantially planar object;
a mounting bar having two sections connected by a threaded fastener, said mounting bar having a first socket and a second socket on each and constructed and arranged to surround said first ball and said second ball respectively;
whereby said substantially planar object may be positioned in any orientation relative to said base.
